(19) United States
(12) Patent Application Publication
(10) Pub. No.: US 2018/0358847 A1
(43) Pub. Date: Dec. 13, 2018

(54) MOTOR

(71) Applicant: FANUC CORPORATION, Yamanashi (JP)

(72) Inventor: Akihiro Hosoda, Yamanashi-ken (JP)

(73) Assignee: FANUC CORPORATION, Yamanashi (JP)

(21) Appl. No.: 16/001,161

(22) Filed: Jun. 6, 2018

(30) Foreign Application Priority Data
Jun. 9, 2017 (JP) 2017-114320

(51) Int. Cl. H02K 1/16

(52) U.S. Cl. CPC H02K 1/16; H02K 5/10

(57) ABSTRACT

The outer shape of a motor is constituted by a stator core. In a cross-sectional view perpendicular to the direction of a rotary shaft of the motor, the outer shape of the stator core is of a shape in which the four corners of a quadrangle are removed. The outer shape of the stator core at each of respective portions from which the four corners have been removed is formed by two straight lines, and angles formed between the straight lines and adjacent sides of the quadrangle are greater than 90° and less than 135°.

### CROSS-REFERENCE TO RELATED APPLICATION

This application is based upon and claims the benefit of priority from Japanese Patent Application No. 2017-114320 filed on Jun. 9, 2017, the contents of which are incorporated herein by reference.

### BACKGROUND OF THE INVENTION

### Field of the Invention

The present invention relates to a motor, an outer shape of which is constituted by a stator core.

### Description of the Related Art

In Japanese Laid-Open Patent Publication No. 2014-082885, it is disclosed that an outer shape of a motor is of a shape obtained by removing the four corners of a quadrangle, in a cross-sectional view perpendicular to the direction of a rotary shaft of the motor.

### SUMMARY OF THE INVENTION

In the motor of the above-described publication, in the stator core, respective portions from which the four corners of the quadrangle are removed, and adjacent quadrangular side portions, which are left remaining after the four corners have been removed (hereinafter also referred to as “adjacent sides of the quadrangle”) form an angle of 90°. As a result, in the case that the motor is mounted on a machine tool, there is a possibility that cutting fluid adhered to the motor may remain on the removed portions. In this case, since housings are attached respectively to both ends of the stator core along the direction of the rotary shaft of the motor, it becomes easy for such accumulated and retained cutting fluid to flow and intrude into the interior of the motor through gaps formed between the stator core and the housings.

In addition, in the case that a resin is applied to the side surfaces of the stator core while the stator core is rotated about the rotary shaft of the motor, there is a possibility that it may become difficult to uniformly apply the resin.

Thus, an object of the present invention is to provide a motor, which is capable of preventing a liquid such as a cutting fluid from remaining in a stagnant state, together with enabling a resin to be uniformly applied to the side surfaces of the stator core.

An aspect of the present invention is characterized by a motor including a stator core that constitutes an outer shape of the motor, wherein, in a cross-sectional view perpendicular to a direction of a rotary shaft of the motor, an outer shape of the stator core is of a shape in which four corners of a quadrangle are removed, and the outer shape of the stator core at each of respective portions from which the four corners have been removed is formed by two straight lines, and angles formed between the straight lines and adjacent sides of the quadrangle are greater than 90° and less than 135°.

According to the present invention, in the stator core, it is possible to prevent a liquid such as a cutting fluid which is adhered to the respective portions from which the four corners have been removed from remaining thereon in a stagnant state. Further, in the case that a resin is applied to the side surfaces of the stator core while the stator core is rotated about the rotary shaft of the motor, it is possible for the resin to be uniformly applied.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a motor according to an embodiment of the present invention;

FIG. 2 is a cross-sectional view of a stator core taken along line II-II of FIG. 1; and

FIG. 3 is a cross-sectional view of a stator core of a comparative example.

### DESCRIPTION OF THE PREFERRED EMBODIMENTS

A preferred embodiment of a motor according to the present invention will be presented and described in detail below with reference to the accompanying drawings.

[Configuration of the Embodiment]

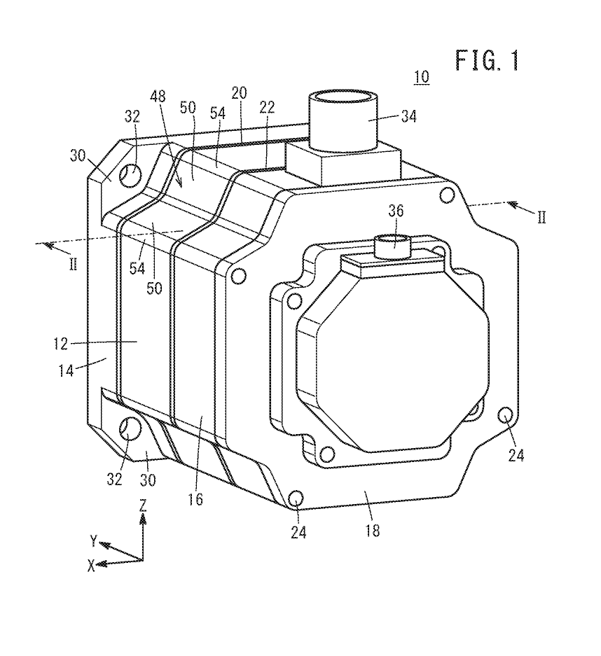

FIG. 1 is a perspective view showing external appearance of a motor 10 according to the present embodiment. The motor 10 includes a stator core 12, a first housing 14 attached to one end portion of the stator core 12 along a direction (Y direction) of the rotary shaft of the motor 10, a second housing 16 attached to another end portion of the stator core 12 along the Y direction, and a bearing holder 18 attached to an end portion of the second housing 16 on an opposite side from that of the stator core 12 along the Y direction.

The outer peripheral surface (side surfaces) of the stator core 12 is exposed to the exterior, and constitutes the outer shape of the motor 10. A resin is applied to the outer peripheral surfaces of the stator core 12, the first housing 14, the second housing 16, and the bearing holder 18. The first housing 14 and the one end portion of the stator core 12 are connected via a seal member 20 such as an adhesive or the like. The other end portion of the stator core 12 and the second housing 16 are connected via a seal member 22 such as an adhesive or the like. The first housing 14, the stator core 12, the second housing 16, and the bearing holder 18 are fastened together in the Y direction by a plurality of tie rods 24 that extend in the Y direction.

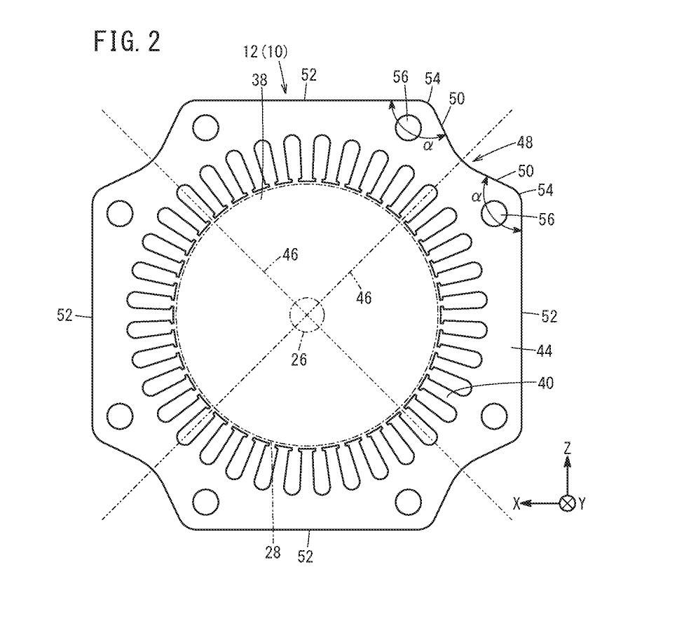

The first housing 14 is a metallic bottomed tubular member, which closes the one end portion of the stator core 12, and together therewith, accommodates one coil end of a stator including the stator core 12 and a non-illustrated stator coil, and one bearing that pivotally supports a rotary shaft 26 and a rotor 28 (see FIG. 2). In this case, a distal end part of the rotary shaft 26 protrudes from an end portion of the first housing 14 on an opposite side from that of the stator core 12 along the Y direction.

Each of the first housing 14, the stator core 12, the second housing 16, and the bearing holder 18 has an outer shape in which the four corners thereof are removed. In addition, by removing the four corners of the first housing 14, flanges 30 are formed on the end portion of the first housing 14. Bolt holes 32 are formed along the Y direction in each of the flanges 30.

In this case, regarding the Z direction shown in FIG. 1 as an upward direction of the motor 10, non-illustrated bolts are inserted through the bolt holes 32, and the bolts are screw-engaged in threaded holes of a non-illustrated machine tool, whereby the motor 10 can be fixed to the machine tool.

The second housing 16 is a metallic tubular member, and accommodates another coil end of the stator, and another bearing that pivotally supports the rotary shaft 26 and the rotor 28. In this case, a first connector 34, which is connected to a cable for supplying electric power to the motor 10 from the exterior, is arranged on the upper portion of the second housing 16. The bearing holder 18 is a metallic bottomed tubular member, which closes the other end portion of the stator core 12, together with supporting the other bearing. A second connector 36, which is connected to a cable for outputting to the exterior detection signals indicating the position and rotation speed of the rotor 28 as detected by a non-illustrated detector, is arranged on the bearing holder 18.

FIG. 2 is a view of the stator core 12 shown in the form of a cross-sectional view perpendicular to the Y direction. In this instance, the outer shape of the stator core 12 will be described with reference to FIGS. 1 and 2. Moreover, in FIG. 2, in order to facilitate understanding, hatching with respect to the stator core 12 is omitted.

The stator core 12 is a tubular member constituted by a magnetic material, and having a hollow portion 38 formed therein for accommodating the rotor 28 which is connected coaxially with the rotary shaft 26. The stator core 12 comprises a plurality of teeth 40, which are disposed at predetermined intervals on the side of the hollow portion 38, and project toward the rotor 28. A non-illustrated stator coil is wound around the plurality of teeth 40. The respective teeth 40 are connected by a ring-shaped core backing 44.

The outer shape of the stator core 12 has a shape in which the four corners of a quadrangle are removed. The respective portions which are left after having removed the four corners are configured as V-shaped corner portions 48, which are recessed from the four corners toward the rotary shaft 26, along two diagonal lines 46 of the quadrangle that pass through the center of the rotary shaft 26. Each of the corner portions 48 has two straight lines 50 located on both sides of the diagonal lines 46, respectively. The two straight lines 50 are connected on the diagonal lines 46. Moreover, the connected portions of the two straight lines 50 on the diagonal lines 46 are slightly curved.

In this case, the two straight lines 50 are formed in a manner so that the angle a formed between each of the straight lines 50 and the adjacent side portions of the quadrangle (hereinafter also referred to as adjacent sides 52 of the quadrangle), which are left remaining after removal of the four corners, is greater than 90° and less than 135°. More preferably, the angle a lies within a range of from 105° to 120°. As a result, each of the straight lines 50 intersects with an adjacent side 52 of the quadrangle, thereby forming a plurality of apexes 54. Moreover, the respective apexes 54 are slightly curved.

In the stator core 12, through holes 56 through which the tie rods 24 are inserted are formed inside each of the apexes 54. In this case, in the stator core 12, some distance is provided between the through holes 56 and the outer peripheral surface (for example, the straight lines 50) of the stator core 12.

Further, as shown in FIG. 1, the first housing 14, the stator core 12, the second housing 16, and the bearing holder 18 have outer shapes from which the four corners thereof have been removed, and each of the corner portions 48 is formed to extend along the Y direction. More specifically, the first housing 14 and the second housing 16, which are connected along the Y direction to both end portions of the stator core 12, and the bearing holder 18, which is connected to the second housing 16, include corner portions corresponding to the respective corner portions 48, and which are recessed in V-shapes on the inner sides thereof.

[Method of Manufacturing the Motor]

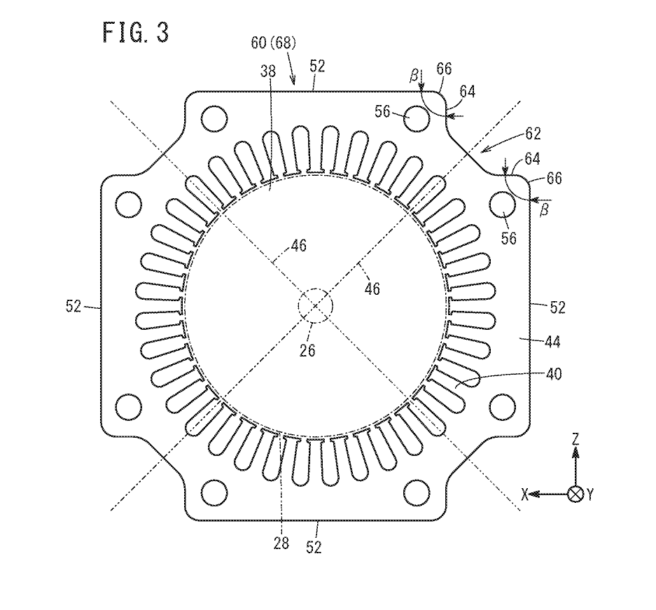

In the case of manufacturing the motor 10 which is configured in the foregoing manner, initially, the seal member 20 is applied to one end portion of the stator core 12, and the one end portion of the stator core 12 and the end portion of the first housing 14 are bonded together. Further, the seal member 22 is applied to the other end portion of the stator core 12, and the other end portion of the stator core 12 and the end portion of the second housing 16 are bonded together. After the seal members 20, 22 have dried, the rotary shaft 26 and the rotor 28, etc., are assembled inside the first housing 14, the stator core 12, and the second housing 16. Then, the first housing 14, the stator core 12, the second housing 16, and the bearing holder 18 are fixed together in the Y direction by the tie rods 24. Thereafter, while the first housing 14, the stator core 12, the second housing 16, and the bearing holder 18 are rotated around the rotary shaft 26, the outer peripheral surfaces of the first housing 14, the stator core 12, the second housing 16, and the bearing holder 18 are coated with a resin using a brush or the like. By drying of the resin, manufacturing of the motor 10 is completed.

[Advantages and Effects of the Embodiment]Advantages and effects of the motor 10 of the present embodiment, which was described above, will be described in comparison with a comparative example shown in FIG. 3. FIG. 3 is a view of a stator core 60 according to the comparative example, in a cross-sectional view perpendicular to the Y direction. In this case as well, the same reference numerals are used to designate the same constituent elements as those of the stator core 12 of the motor 10, and detailed description of such features is omitted.

With the stator core 60 of the comparative example, corner portions 62, which are formed by removing the four corners of a quadrangle, have outer shapes formed so as to be recessed inwardly from the four corners. However, the corner portions 62 have outer shapes that are recessed toward the rotary shaft 26 from the four corners of the quadrangle. Further, the angle β formed between two straight lines 64 on both sides of the respective corner portions 62 and the adjacent sides 52 of the quadrangle is 90°. Moreover, the two straight lines 64 intersect with the adjacent sides 52 of the quadrangle, thereby forming respective apexes 66.

In accordance with these features, in the stator core 60 of the comparative example, in the case that a motor 68 having the stator core 60 is fixed to a machine tool with the Z direction shown in FIG. 3 being treated as an upward direction, there is a possibility that cutting fluid, which is used for machining the object to be machined, may remain in each of the corner portions 62. As a result, the accumulated and retained cutting fluid is likely to flow and intrude into the interior of the motor 68 through gaps formed between the stator core 60 and the first housing 14 and the second housing 16.

Further, in the case that a resin is applied to the outer peripheral surface of the motor 68 using a brush or the like while the motor 68 is rotated around the rotary shaft 26, then since the angles β formed by the straight lines 64 and the adjacent sides 52 of the quadrangle are 90°, it is difficult for the resin to be applied to the corner portions 62. As a result, there is a possibility that it may become difficult to uniformly apply the resin to the outer peripheral surface of the stator core 60.

Furthermore, since the angle β is 90°, the distance between the straight lines 64 and the through holes 56 in the stator core 60 is reduced. Consequently, when the seal members 20, 22 are applied entirely over the surfaces of the one end portion and the other end portion of the stator core 60, and the stator core 60 is bonded together with the first housing 14 and the second housing 16, the seal members 20, 22 protrude out to the exterior, or the seal members 20, 22 penetrate into the through holes 56. Thus, when the seal members 20, 22 are applied to portions on inner sides of the through holes 56 in the one end portion and the other end portion of the stator core 60, and the stator core 60 is bonded together with the first housing 14 and the second housing 16, gaps tend to be easily formed between the stator core 60 and the first housing 14 and the second housing 16.

On the other hand, when the angle β is 135°, the outer shape of the stator core 60 becomes an octagon. In this case, it is difficult to secure spaces for forming the bolt holes 32 in the flanges 30.

In contrast thereto, with the motor 10 according to the present embodiment, as shown in FIG. 2, the angle a between the straight lines 50 and the adjacent sides 52 of the quadrangle is greater than 90° and less than 135°. Consequently, even if the cutting fluid is adhered to the corner portions 48, retention of the cutting fluid can be prevented.

Further, in the case that the outer peripheral surfaces of the first housing 14, the stator core 12, the second housing 16, and the bearing holder 18 are coated with a resin while the first housing 14, the stator core 12, the second housing 16, and the bearing holder 18 are rotated around the rotary shaft 26, it is possible for the resin to be uniformly applied.

Furthermore, if the angle a lies within a range of from 105° to 120°, the distance between the straight lines 50 and the through holes 56 in the stator core 12 becomes larger than in the comparative example shown in FIG. 3. Consequently, in the case that the seal members 20, 22 are applied entirely over the surfaces of the one end portion and the other end portion of the stator core 12, and the stator core 12 is bonded together with the first housing 14 and the second housing 16, it is possible to prevent the seal members 20, 22 from protruding out to the exterior, or to prevent the seal members 20, 22 from penetrating into the through holes 56.

Further still, by positioning the two straight lines 50 that form the respective corner portions 48 on both sides of the diagonal lines 46 of the quadrangle, it becomes easier for the angle a to be set within the aforementioned range.

Further, since the outer shape of the stator core 12 is of a shape obtained by removing the four corners of the quadrangle along the Y direction, the respective effects described above are more easily obtained. In addition, since the corner portions are formed in the first housing 14, the second housing 16, and the bearing holder 18 along the Y direction so as to be continuous with the corner portions 48 of the stator core 12, it is easy for the motor 10 as a whole to achieve the above-described effects, together with facilitating the passage of bolts through the bolt holes 32.

The present invention is not limited to the embodiments described above, and it goes without saying that the embodiments can be freely modified within a range that does not deviate from the essence and gist of the present invention as set forth in the appended claims.

[Technical Concepts Obtained from the Embodiment]

Technical concepts which can be grasped from the above-described embodiment will be described below.

The motor (10) includes the stator core (12) that constitutes an outer shape of the motor (10). In a cross-sectional view perpendicular to the direction of the rotary shaft (26) of the motor (10), an outer shape of the stator core (12) is of a shape in which four corners of a quadrangle are removed, and the outer shape of the stator core (12) at each of the respective portions (48) from which the four corners have been removed is formed by two straight lines (50), and the angles (α) formed between the straight lines (50) and the adjacent sides (52) of the quadrangle are greater than 90° and less than 135°.

In accordance with these features, in the stator core (12), it is possible to prevent a liquid such as a cutting fluid which is adhered to the respective portions (48) from which the four corners have been removed from remaining thereon in a stagnant state. Further, in the case that resin is applied to the side surfaces of the stator core (12) while the stator core (12) is rotated about the rotary shaft (26) of the motor (10), it is possible for the resin to be uniformly applied.

In a cross-sectional view perpendicular to the direction of the rotary shaft (26) of the motor (10), the angles (α) formed between the straight lines (50) and the adjacent sides (52) of the quadrangle may lie within a range of from 105° to 120°. Owing to this feature, in the case that the through holes (56) are formed in the stator core (12) in proximity to the straight lines (50) and the adjacent sides (52) of the quadrangle, the distance between the straight lines (50) and the through holes (56) increases. As a result, in the case that the seal members (20, 22) are applied entirely over the surfaces of both end portions of the stator core (12), and both end portions of the stator core (12) are bonded together with the housings (14, 16), it is possible to prevent the seal members (20, 22) from protruding to the exterior, or to prevent the seal members (20, 22) from penetrating into the through holes (56).

Further, by locating the two straight lines (50) on both sides of the diagonal lines (46) of the quadrangle, it becomes easier for the angle (α) to be set within the aforementioned range.

Furthermore, by making the outer shape of the stator core (12) be of a shape obtained by removing the four corners of the quadrangle along the direction of the rotary shaft (26) of the motor (10), the respective effects described above are more easily obtained.

What is claimed is:

1. A motor including a stator core that constitutes an outer shape of the motor, wherein:
in a cross-sectional view perpendicular to a direction of a rotary shaft of the motor, an outer shape of the stator core is of a shape in which four corners of a quadrangle are removed, and the outer shape of the stator core at each of respective portions from which the four corners have been removed is formed by two straight lines, and angles formed between the straight lines and adjacent sides of the quadrangle are greater than 90° and less than 135°.

2. The motor according to claim 1, wherein:
in the cross-sectional view perpendicular to the direction of the rotary shaft of the motor, the angles formed between the straight lines and the adjacent sides of the quadrangle lie within a range of from 105° to 120°.

3. The motor according to claim 1, wherein the two straight lines are located on both sides of a diagonal line of the quadrangle.

4. The motor according to claim 1, wherein the outer shape of the stator core is of a shape obtained by removing the four corners of the quadrangle along the direction of the rotary shaft of the motor.
